(19) United States
(12) Patent Application Publication
(10) Pub. No.: US 2005/0214484 A1
(43) Pub. Date: Sep. 29, 2005

(54) Ink-jet recording medium

(75) Inventor: Takashi Kobayashi, Shizuoka-ken (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/088,810

(22) Filed: Mar. 25, 2005

(30) Foreign Application Priority Data
Mar. 25, 2004 (JP) 2004-90480

(51) Int. Cl. B41M 5/00

(52) U.S. Cl. 428/32.34

(57) ABSTRACT

The present invention is an ink-jet recording medium having an ink-receiving layer including silica produced by a gas-phase process and a water-soluble resin on or over a support, wherein the density of silanol groups of the silica is from 1.0 to 2.3 SiOH groups/nm².

### CROSS-REFERENCE TO RELATED APPLICATION

This application claims priority under 35 U.S.C. 119 from Japanese Patent Application No. 2004-90480, the disclosure of which is incorporated by reference herein.

### BACKGROUND OF THE INVENTION

1. Field of the Invention

The present invention relates to a recording medium suitable for ink-jet recording by use of a liquid ink such as water-color ink or oil-based ink, or a solid ink, which is a solid at ambient temperature and is liquefied to print an image, and specifically, to an ink-jet recording medium superior in ink-receiving performance.

2. Description of the Related Art

In recent years, with rapid development of information industry, various information-processing systems have been developed. Recording methods and devices suitable for the information-processing systems have also been developed, and have been put to practical use.

The inkjet recording method, among the above-mentioned recording methods, has come to be widely used not only for office use but also for home use, for the following reasons: recording images onto various recording materials is possible; the hardware is relatively inexpensive and compact; and the recording is not noisy.

With a rise in the resolution of ink-jet printers in recent years, so-called photograph-like high image-quality recorded matter has become obtainable. Moreover, with the development of hardware, various recording media for ink-jet recording have also been developed.

Characteristics required for the above-mentioned recording media for ink-jet recording are generally as follows: (1) the media have rapid drying ability (i.e., a high ink-absorbing rate); (2) the media allow the diameter of ink dots to be proper and even (that is, the media do not cause bleeding); (3) the media have a good granularity; (4) the media allow ink dots having high circularity; (5) the media allow high color density; (6) the media allow high chromaticness (that is, the media do not exhibit dullness); (7) the media have good light resistance, gas resistance and water resistance in an image-printed area; (8) the media have a high degree of whiteness; (9) the media have a good storability (that is, the media neither yellow nor cause bleeding during long-term storage); (10) the media do not deform easily and have good dimensional stability (that is, the media exhibit a sufficiently small amount of curl; (11) the media have good running properties with respect to hardware. In order to use an ink-jet recording medium as photographic glossy paper, which is used to obtain photograph-like high image-quality recorded matter, in addition to the above-mentioned characteristics, glossiness, surface smoothness, and photographic paper texture similar to that of silver salt photographs are also required.

As ink-jet recording media satisfying the above-mentioned requirements, ink-jet recording media having at least an ink-receiving layer containing silica produced by a gas-phase process on or over a support are known (see, for example, Japanese Patent Application Laid-Open (JP-A) Nos. 2001-96897 and 2002-127593).

Such ink-jet recording media having an ink-receiving layer containing silica produced by a gas-phase process are widely used since they have a high glossiness and good ink absorptivity.

In order to reproduce photographic quality images, it has been desired in recent years that inkjet recording media have such an ink absorptivity that the media can sufficiently absorb ink from printers for obtaining photographic quality images (ink-jet amount: about 20 mL/m²). Hitherto, desired ink absorptivity has therefore been secured by setting the thickness of their ink-receiving layers to within the range of 30 to 40 μm. However, when the thickness of the ink-receiving layers is thick, problems are caused, such as increased curling of the ink-jet recording media and easy generation of defects such as cracks.

Among the above-mentioned problems, curling is overcome by optimizing the thickness of polyethylene layers formed on the front and rear faces of resin-coated paper (RC paper), which is used as a support, by adjusting the water content in the base paper of the ink-jet recording media, or by adjusting the degree of beating when the base paper is made. Furthermore, the above-mentioned problem of cracking is overcome by adding a plasticizer of polyvinyl alcohol or a low-Tg emulsion to the ink-jet recording media.

However, if the ink-absorbing volume of an ink-receiving layer can be increased while using the same amount of silica that conventionally used media contain, the ink-receiving layer can achieve the same ink-receiving capability that conventional media have and further realize a smaller thickness. As a result, the generation of defects of ink-jet recording media, such as curling and cracking, can be prevented. In the meantime, it is preferred that the ink-absorbing volume of ink-jet recording media per unit amount of silica used is large. This is because the ink absorptivity of the media can be improved and a decrease in beading and bronzing thereof can be realized. Thus, further improvement in ink absorptivity is desired.

Therefore, there is a need for ink-jet recording media having high ink absorptivity.

### SUMMARY OF THE INVENTION

The inventor of the invention has found out that control of the number of silanol groups which silica produced by a gas-phase process and contained in an ink-receiving layer has and increasing the porosity of the layer improve ink absorptivity. Thus, the invention has been made. The above-mentioned need is attained by the following invention.

The invention provides an ink-jet recording medium having an ink-receiving layer containing silica produced by a gas-phase process and a water-soluble resin on or over a support, wherein the density of silanol groups of the silica (i.e., the number of SiOH groups of silica per nm²) is from 1.0 to 2.3 SiOH groups/nm².

### DETAILED DESCRIPTION OF THE INVENTION

The ink-jet recording medium of the invention will be described in detail hereinafter.

The ink-jet recording medium of the invention has an ink-receiving layer containing silica produced by a gas-phase process and a water-soluble resin on or over a support, and the density of silanol groups of the silica is from 1.0 to 2.3 SiOH groups/nm².

Since the ink-receiving layer contains silica produced by a gas-phase process and having a silanol group density of 1.0 to 2.3 SiOH groups/nm² (hereinafter referred to as the “gas-phase (process) silica in the invention” as the case may be), the ink-jet recording medium of the invention has improved ink absorptivity of the medium, such as an ink-absorbing rate and an ink-absorbing volume thereof. In the ink-jet recording medium of the invention, generation of beading and bronze glossiness can be restrained with the improvement of the ink absorptivity. Moreover, the color density and ozone resistance of images formed can be improved with the improvement of the ink absorptivity.

<Ink-Receiving Layer>

The ink-receiving layer in the invention includes silica produced by a gas-phase process and having a silanol group density of 1.0 to 2.3 SiOH groups/nm², and a water-soluble resin. The layer may contain fine particles made of an inorganic material different from the gas-phase process silica, a hardener, a cationic resin, a water-soluble metal compound, a water-soluble sulfur compound, a mordant, and/or a surfactant, if necessary.

—Gas-Phase Process Silica—

Generally, silica fine particles are roughly classified into wet process particles and dry process (gas-phase process) particles in accordance with the production process thereof. In a wet process mainly conducted, silicate is decomposed with an acid to generate active silica and the active silica is appropriately polymerized, aggregated and precipitated to yield hydrous silica. Meanwhile, in a gas-phase process mainly conducted, silicon halide is hydrolyzed in a gas phase at a high temperature (flame hydrolyzing method), or silica sand and coke are heated with an arc in an electrical furnace to reduce and gasify the silica sand, and the resultant gas is then oxidized with air (arc method). In these methods, anhydrous silica is obtained. The “silica produced by a gas-phase process” or “gas-phase process silica” in the invention means anhydrous silica fine particles obtained by the gas-phase process.

The gas-phase process silica is different from hydrous silica from the viewpoints of the density of silanol groups and the presence or absence of pores, and exhibits properties different from those of hydrous silica. Therefore, the gas-phase process silica is suitable for formation of a three-dimensional structure having a high porosity. The reason for this is not clear but is presumed as follows. The density of silanol groups on the surfaces of hydrous silica fine particles is as large as 5-8 SiOH groups/nm² and the silica fine particles easily and densely aggregate. Meanwhile, the density of silanol groups on the surfaces of the fine particles of the gas-phase process silica used in conventional ink-receiving layers is from about 2.5 to 3 SiOH groups/nm², and the particles thinly flocculate, whereby a structure having a high porosity may be obtained. In the invention, bulky gas-phase process silica having a silanol group density of about 1.0 to about 2.3 [SiOH groups/nm²], which is smaller than that of the conventional gas-phase process silica, is used. As a result, a three-dimensional structure having a high porosity is formed. It is therefore possible to form an ink-receiving layer having higher ink absorptivity than ink-receiving layers including the conventional gas-phase process silica (i.e., gas-phase process silica having a silanol group density of about 2.5 to about 3 [SiOH groups/nm²]).

The phrase “silanol group density (or the density of silanol groups)” means the number of silanol groups per nm² of the surfaces of silica fine particles. The silanol group density of the gas-phase process silica used in the invention is from 1.0 t 2.3 [SiOH groups/nm²]. If the silanol group density of the gas-phase process silica is less than 1.0, the silica particles are not easily dispersed in an aqueous solvent and easily aggregate. Consequently, the glossiness of the ink-receiving layer lowers, and a photograph-like image cannot be obtained. If the silanol group density is more than 2.3, the ink absorptivity lowers and beading or bronze glossiness remarkably occurs. Consequently, the color density or ozone resistance of an image formed lowers.

Moreover, the silanol group density of the gas-phase process silica in the invention is preferably from 1.5 to 2.5 [SiOH groups/nm²], and more preferably from 1.5 to 1.9 [SiOH groups/nm²] from the viewpoints of the dispersibility, glossiness and ink absorptivity of the silica. The silanol group density of the gas-phase process silica can be measured by, for example, a lithium aluminum hydride method described in “TECHNICAL BULLETIN AEROSIL NO. 17 “BASIC PERFORMANCE OF AEROSIL” p. 41, Nippon Aerosil Co., Ltd.”

Since the gas-phase process silica in the invention has a particularly large specific surface area, the ink absorptivity and ink holding efficiency thereof are high. If the silica is dispersed to have an appropriate particle size, transparency can be given to the ink-receiving layer due to the silica having a low refractive index. Accordingly, a high color density and a good color-forming property can be obtained. The ink-receiving layer being transparent is preferable for an article which is required to have transparency, such as an overhead projector (OHP) sheet. Moreover, the ink-receiving layer being transparent is also preferable for a recording sheet such as photographic glossy paper, since a high color density, a good color-forming property and glossiness can be obtained.

The average primary particle diameter of the gas-phase process silica is preferably 20 nm or smaller, more preferably 10 nm or smaller, and most preferably 3 to 10 nm. The silanol groups of the gas-phase process silica particles form a hydrogen bond and the particles easily adhere to each other. Therefore, when the average primary particle diameter is 20 nm or smaller, a structure having a high porosity can be formed.

The BET specific surface area of the gas-phase process silica in the invention is preferably 180 m²/g or more, more preferably 200 m²/g or more, and even more preferably 250 m²/g or more. When the BET specific surface area of the gas-phase process silica in the invention is 180 m²/g or more, the transparency of the ink-receiving layer can be improved. For example, when a white support, such as resin-coated paper, is used, the density of an image printed thereon can be improved.

The “BET specific surface area” in the invention means a value calculated from the amount Vm [mL/g] of nitrogen gas which is adsorbed by the surface of silica in a state of monomolecular layer and which is measured with an automatic BET specific surface area measuring device (SOPTPMATIC SERIES 1800 manufactured by Carlo-ERBA Co.), and the following equation (A).
BET specific surface area=4.35×Vm [mL/g]

The gas-phase process silica in the invention, which has a silanol group density of 1.0 to 2.3 [SiOH groups/nm²], can be produced in accordance with a method selected appropriately from methods described in, for example, JP-A No. 9-71411, 2000-19131, 2000-264621 and 2002-256170. It is particularly preferable in the invention that the gas-phase process silica in the invention is produced by treating ordinary gas-phase process silica, which has not been surface-treated, with alkylsilane. The “alkylsilane treatment” means treatment of silica fine particles with alkylsilane which treatment is conducted to obtain the gas-phase process silica in the invention.

A typical method for conducting the alkylsilane treatment to produce the gas-phase process silica in the invention, which typical method does not limit a method for producing the gas-phase process silica in the invention, will be explained. In this method, ordinary gas-phase process silica, which has not been surface-treated, is brought into contact with vapor of alkylsilane. The alkylsilane vapor is diluted with an inactive gas such as nitrogen so that the concentration of the alkylsilane vapor becomes a desired value. Thereby, the number of silanol groups on the surfaces of the silica fine particles can be controlled. The alkylsilane may be appropriately selected from known alkylsilanes. Examples of the alkylsilane include monomethyltrichlorosilane, dimethyldichlorosilane, trimethylchlorosilane, and hexamethyldisilazane, and mixtures thereof. The alkylsilane is preferably monomethyltrichlorosilane, dimethyldichlorosilane, or a mixture thereof.

The reaction temperature in the method in which the alkylsilane is used is preferably from about 300 to 650° C. Specifically, when monomethyltrichlorosilane, dimethyldichlorosilane, or a mixture thereof is used as the alkylsilane(s), the reaction temperature is preferably from 400 to 500° C. In the invention, the mol ratio of the alkylsilane to the inactive gas contained in the mixed vapor thereof can be appropriately and experimentally determined in order to adjust the number of silanol groups per nm² of the surfaces of the silane fine particles in the range of 1.0 to 2.3.

Moreover, the alkylsilane treatment can be not only the above-described method (gas-phase method) in which the alkylsilane is used but also a method in which the ordinary gas-phase silica, which has not been surface-treated, is reacted with the alkylsilane in a solvent such as hexane (liquid-phase method).

—Fine Particles of Other Inorganic Material—

In the invention, the gas-phase process silica in the invention may be used together with fine particles of an inorganic material different from the silica, as far as attainment of the objects of the invention is not hindered. Specific examples of the inorganic material fine particles include ordinary gas-phase process silica, which is not surface-treated, hydrous silica particles, colloidal silica, titanium dioxide, barium sulfate, calcium silicate, zeolite, kaolinite, halloysite, mica, talc, calcium carbonate, magnesium carbonate, calcium sulfate, boehmite, and pseudo-boehmite fine particles.

When the inorganic material fine particles are used together with the gas-phase process silica in the invention, the content of the gas-phase process silica in the invention is preferably 60% by mass or more, and more preferably 70% by mass or more to the total amount of this silica and the inorganic material fine particles.

In the invention, the content of the gas-phase process silica in the invention in the ink-receiving layer is preferably from 40 to 85% by mass, and more preferably from 50 to 75% by mass from the viewpoints of ink absorptivity, beading and bronzing.

—Water-Soluble Resin—

Examples of the water-soluble resin used in the invention include polyvinyl alcohol (PVA), polyvinyl acetal, cellulose resins (such as methylcellulose (MC), ethylcellolose (EC), hydroxyethylcellose (HEC), and carboxymethylcellolose (CMC)), chitins, chitosans, starch, resins having ether bonds (such as polyethylene oxide (PEO), polypropylene oxide (PPO), polyethylene glycol (PEG) and polyvinyl ether (PVE)), resins having amide groups or amide bonds (such as polyacrylamide (PAAM) and polyvinyl pyrrolidone (PVP)), and resins having carboxyl groups as dissociable groups (such as polyacrylic acid salts, maleic acid resin, alginic acid salts, and gelatins. One of these resins may be used alone, or two or more of them can be used together.

The water-soluble resin is preferably polyvinyl alcohol. When polyvinyl alcohol and other water-soluble resin are used together, the content of polyvinyl alcohol in the entire water-soluble resin is preferably at least 90% by mass, and more preferably at least 95% by mass.

Examples of polyvinyl alcohol include polyvinyl alcohol (PVA), cation-modified polyvinyl alcohol, anion-modified polyvinyl alcohol, silanol-modified polyvinyl alcohol and polyvinyl alcohol derivatives. One of these polyvinyl alcohols may be used alone, or two or more of them can be used together. When two or more of the polyvinyl alcohols are used together, it is preferable to use polyvinyl alcohol having a polymerization degree of 1000 or less and polyvinyl alcohol having a polymerization degree of 2000 or more together. In such a case, aggregation of the inorganic material fine particles (poval shock) can be suppressed.

The polyvinyl alcohol has hydroxyl groups in the structural units thereof. This hydroxyl groups and the silanol groups on the surface of the gas-phase process silica in the invention form hydrogen bonds, whereby a three-dimensional network structure having, as chain units, secondary particles of the gas-phase process silica in the invention is easily formed. It is thought that the reason for this is that an ink-receiving layer with a porous structure having a high porosity can be formed due to the structure of the three-dimensional network structure. Also, it is thought that hydrophobic moieties of the gas-phase process silica in the invention and the acetyl groups of polyvinyl alcohol form hydrophobic bonds, whereby the porosity of the porous structure is further enhanced.

In ink-jet recording, the porous ink-receiving layer thus obtained rapidly absorbs ink due to capillarity, so that almost completely round dots without ink bleeding can be formed.

In order to prevent a drop in the strength of the ink-receiving layer or cracking of the layer when an ink-receiving layer applied is dried, which is caused by the content of polyvinyl alcohol being excessively small, and to prevent easy clogging of the pores of the layer by the resin and in turn decreases in the porosity and the ink absorptivity of the ink-receiving layer, which are caused by the content of polyvinyl alcohol being excessively large, the content of polyvinyl alcohol (water-soluble resin) is preferably from 9 to 40% by mass, and more preferably from 12 to 33% by mass with respect to the total solid content of the ink-receiving layer.

The number-average molecular weight of polyvinyl alcohol is preferably 1800 or more, and more preferably 2000 or more in order to prevent the ink-receiving layer from being cracked. Polyvinyl alcohol preferably has a saponification degree of 88% or more from the viewpoints of the transparency of the ink-receiving layer and the viscosity of the coating solution for forming this layer.

The ratio of the amount (i) of the gas-phase process silica in the invention, or, when the silica is used together with other inorganic material fine particles, the total amount of the gas-phase process silica in the invention and the inorganic material fine particles, to the amount (p) of polyvinyl alcohol, or, when polyvinyl alcohol is used together with other water-soluble resin, the amount of all the water-soluble resins, [that is, the PB ratio (i:p)] greatly influences the film structure of the ink-receiving layer. If the PB ratio increases, the porosity, the pore volume and the surface area (per unit mass) increase.

Specifically, the PB ratio (i:p) is preferably from 1.5:1 to 10:1 in order to prevent a drop in the strength of the ink-receiving layer or cracking when an ink-receiving layer applied is dried, which is caused by the PB ratio being excessively high, and to prevent clogging of the pores of the layer by the resin and in turn decreases in the porosity and the ink absorptivity of the ink-receiving layer, which are caused by the PB ratio being excessively low.

When the ink-jet recording medium is conveyed by the carrying system of an ink-jet printer, stress may be applied to the medium. It is therefore necessary that the ink-receiving layer have sufficient film strength. When the medium is cut into sheets, this is also necessary in order to prevent the ink-receiving layer from cracking or peeling away from the medium.

In this case, the PB ratio is preferably from 7:1 or less. The PB ratio is preferably from 2:1 or more in order to secure rapid ink absorptivity of the ink-receiving layer in any ink-jet printer.

For example, when a coating solution in which the gas-phase process silica in the invention and the water-soluble resin are completely dispersed at a PB ratio in the range of 2:1 to 7:1 in water is applied to a support and the resultant coating layer is dried, it is possible to easily form a three-dimensional network structure having, as chain units, secondary particles of the gas-phase process silica in the invention, and a transparent porous film having an average pore diameter of 30 nm or less, a porosity of 50 to 80%, a pore specific volume of 0.5 mL/g or more, and a specific surface area of 100 m²/g or more.

—Hardener—

The ink-receiving layer of the ink-jet recording medium of the invention may contain a hardener which can harden the water-soluble resin. The hardener causes the water-soluble resin to be cross-linked, whereby the coating layer is hardened. As a result, the ink-receiving layer is formed.

A boron compound is preferably used to cross-link the water-soluble resin, particularly polyvinyl alcohol. Examples of the boron compound include borax, boric acid, borates such as orthoborates, InBO₃, ScBO₃, YBO₃, LaBO₃, Mg₃(BO₃)₂, and Co₃(BO₃)₂, diborates such as Mg₂B₂O₅ and Co₂B₂O₅, metaborates such as LiBO₂, Ca(BO₂)₂, NaBO₂, and KBO₂, tetraborates such as Na₂B₄O₇.10H₂O, and pentaborates such as KB₅O₈.4H₂O, Ca₂B₆O₁₁.7H₂O, and CsB₅O₅. The boron compound is preferably borax, boric acid, and/or borate because they can rapidly cause the cross-linking reaction. The boron compound is more preferably boric acid.

The hardener for the water-soluble resin may be a compound other than the above-mentioned boron compounds. Specific examples thereof include aldehyde compounds such as formaldehyde, glyoxal, succinaldehyde, glutaraldehyde, dialdehyde starch, and dialdehyde derivatives of plant gum; ketone compounds such as diacetyl, 1,2-cyclopentandione, and 3-hexene-2,5-dione; active halogen compounds such as bis(2-chloroethyl)urea, bis(2-chloroethyl)sulfone, and a sodium salt of 2,4-dichloro-6-hydroxy-s-triazine, active vinyl compounds such as divinylsulfone, 1,3-bis(vinylsulfonyl)-2-propanol, N,N′-ethylenebis(vinylsulfonylacetamide), divinyl ketone, 1,3-bis(acryloyl)urea, and 1,3,5-triacryloyl-hexahydro-s-triazine; N-methylol compounds such as dimethylolurea, and methyloldimethylhydantoin; melamine compounds such as trimethylolmelamine, alkylated methylolmelamine, melamine, benzoguanamine, and melamine resin; and epoxy compounds such as ethylene glycol diglycidyl ether, propylene glycol diglycidyl ether, polyethylene glycol diglycidyl ether, diglycerin polyglycidyl ether, spiroglycol diglycidyl ether, and polyglycidyl ether of phenol resin, isocyanate compounds such as 1,6-hexamethylene diisocyanate and xylylene diisocyanate; aziridine compounds disclosed in U.S. Pat. Nos. 3,017,280 and 2,983,611; carbodiimide compounds disclosed in U.S. Pat. No. 3,100,704; ethylene imino compounds such as 1,6-hexamethylene-N,N′-bisethylene urea; halogenated carboxyaldehyde compounds such as mucochloric acid and mucophenoxychloric acid; dioxane compounds such as 2,3-dihydroxydioxane; metal-containing compounds such as titanium lactate, aluminum sulfate, polyaluminum chloride, chromium alum, potassium alum, zirconyl acetate, and chromium acetate; polyamine compounds such as tetraethylenepentamine; hydrazide compounds such as adipic acid dihydrazide; low molecular-weight compounds or polymers having two or more oxazoline groups; anhydrides, acid chlorides or bis(sulfonate) compounds of polyacids disclosed in U.S. Pat. Nos. 2,725,294, 2,725,295, 2,726,162, and 3,834,902; and active ester compounds disclosed in U.S. Pat. Nos. 3,542,558 and 3,251,972.

Only one cross-linking agent may be used or two or more cross-linking agents may be used in combination.

In the invention, the cross-linking and hardening is preferably carried out at least by adding the hardener to a coating solution including the gas-phase process silica in the invention and the water-soluble resin (hereinafter, referred to as a “first coating solution”), and/or a basic solution described below; and adding the basic solution having a pH of 7.1 or more (hereinafter, referred to as a “second coating solution”) to a coating layer formed by applying the first coating solution to a support (1) simultaneously with the first coating solution being applied to a support to form the coating layer or (2) before the coating layer exhibits a decreasing rate of drying at the time that the coating layer is dried.

The basic solution having a pH of 7.1 or more (the “second coating solution”) may contain as a base an organic or inorganic compound exhibiting basicity (examples of which include metal complexes and salts of organic acids), or a base precursor besides an organic cationic resin having a primary, secondary or tertiary amino group, which will be described later. Examples of such a compound include ammonium salt compounds in which one of the components of the salt is ammonia, low molecular weight compounds or oligomer compounds each having a primary, secondary or tertiary amino group, hydroxides of quaternary ammonium salts, nitrogen-containing heterocyclic compounds, hydroxides of alkali metals or alkaline earth metals, and salts of acids.

Specific examples thereof include ammonia water, ammonium carbonate, ammonium acetate, zirconium ammonium carbonate, ammonium chloride, ammonium sulfate, ammonium toluenesulfonate, polymer having an acidic group, ammonium salts of latex, triethanolamine, triethylamine, butylamine, diallylamine, piperidine, 2-methylpiperidine, dimethylpiperidine, imidazole, tetramethylammonium hydroxide, sodium acetate, and guanidine.

In order to adjust the surface pH of the ink-jet recording medium, it is preferable to use, as the base, an ammonium salt compound among these compounds.

In the case of a boron compound, addition of the hardener is preferably performed as follows. In a case that the ink-receiving layer is a layer formed by cross-linking and hardening a coating layer obtained by applying a coating solution including the gas-phase process silica in the invention and polyvinyl alcohol (a first coating solution), the cross-linking and hardening are performed by applying a basic solution having a pH of 7.1 or more (a second coating solution) to a coating layer formed by applying the first coating solution (1) simultaneously with the first coating solution being applied to a support to form the coating layer or (2) before the coating layer exhibits a decreasing rate of drying at the time that the coating layer is dried. The boron compound serving as the hardener may be incorporated into the first coating solution or the second coating solution, or may be incorporated into both of the solutions.

The content of the hardener in the ink-receiving layer in the invention is preferably from 1 to 50%, and more preferably from 5 to 40% by mass with respect to the water-soluble resin.

The second coating solution may contain a metal compound. The metal compound can be one which is stable in the basic solution having pH of 7.1 or higher. The metal compound may be a metal salt, a metal complex compound, an inorganic oligomer, or an inorganic polymer. The metal compound is preferably an inorganic mordant described later. The metal compound is more preferably a zirconium compound or a zinc compound, and still more preferably a metal compound having a valency of three or more (e.g. zirconium compound). Examples thereof include ammonium zirconium carbonate, ammonium zinc acetate, ammonium zinc carbonate, ammonium zirconium nitrate, potassium zirconium carbonate, and ammonium zirconium citrate.

—Cationic Resin—

The gas-phase process silica in the invention, and optional other inorganic material fine particles are preferably used in the state in which they are dispersed in a cationic resin.

The cationic resin is not limited to any especial kind, and is preferably a water-soluble or aqueous emulsion type resin. Examples of the cationic resin include polycationic resins such as dicyan cationic resins such as dicyandiamide-formalin polycondensate, polyamine cationic resins such as dicyanamide-diethylenetriamine polycondensate, epichlorohydrin-dimethylamine addition polymer, dimethyl diallyl ammonium chloride-SO₂ copolymer, and diallylamine salt-SO₂ copolymer, dimethyl diallyl ammonium chloride polymer, polymer of an allylamine salt, polymer of a dialkylaminoethyl(meth)acrylate quaternary salt, and acrylamide-diallylamine salt copolymer. Dimethyl diallyl ammonium chloride polymer, monomethyl diallyl ammonium chloride polymer and polyamidine are preferable. Dimethyl diallyl ammonium chloride polymer and monomethyl diallyl ammonium chloride polymer are particularly preferable from the viewpoint of water resistance thereof. One cationic resin may be used alone, or two or more cationic resins may be used together. A copolymer of dialkylaminoethyl(meth)acrylate quaternary salt and styrene is also preferable as the cationic resin. The weight-average molecular weight of the cationic resin is preferably from 1,000 to 100,000, more preferably from 3,000 to 70,000, and still more preferably from 4,000 to 50,000 from the viewpoints of dispersibility of the inorganic fine particles (the gas-phase process silica in the invention), the viscosity of the first coating solution, and water resistance and glossiness of the ink-receiving layer.

The content of the cationic resin contained in the ink-receiving layer is preferably from 1 to 30 parts by mass, and more preferably from 3 to 20 parts by mass with respect to 100 parts by mass of the total of the gas-phase process silica in the invention and other inorganic material fine particles. A method for adding the cationic resin to the gas-phase process silica in the invention is not particularly limited, and may be, for example, a method (1) of adding gas-phase process silica powder or gas-phase process silica slurry to an aqueous solution containing the cationic resin, or a method (2) of adding the cationic resin to a gas-phase process silica slurry solution. In the above method (1), the cationic polymer may be added to a system in a small amount before the gas-phase process silica in the invention and so on are pulverized and dispersed, pulverized and dispersed into a desired particle size, and the cationic polymer may be further added to the system.

—Water-Soluble Metal Compound—

In the ink-jet recording medium of the invention, it is preferable that the ink-receiving layer contains a water-soluble metal compound in order to improve water resistance of images formed and bleeding resistance thereof. The water-soluble metal compound in the ink-receiving layer can interact with liquid ink containing an anionic dye as a colorant to stabilize the colorant and to further improve water resistance and bleeding resistance.

The water-soluble metal compound may be a water-soluble metal salt having a valency of two or more. Examples thereof include inorganic metal salts such as halides, hexafluorosilyl compounds, sulfates, thiosulfates, phosphates, chlorates, and nitrates of typical metal elements, such as magnesium, calcium, strontium, barium, aluminum, zirconium, gallium, indium, thallium, germanium, tin, lead, and bismuth. Metals salts of organic acids can also be used if the salts are water-soluble.

Specific examples thereof include magnesium chloride, calcium chloride, barium chloride, aluminum chloride, tin chloride, lead chloride, strontium chloride, polyaluminum chloride, magnesium sulfate, calcium sulfate, aluminum sulfate, aluminum potassium sulfate, magnesium chlorate, magnesium phosphate, magnesium nitrate, calcium nitrate, barium nitrate, aluminum nitrate, strontium hydroxide, aluminum lactate, zirconium acetylacetonate, zirconyl acetate, zirconyl sulfate, zirconium ammonium carbonate, zirconyl stearate, zirconyl octate, zirconyl nitrate, zirconium oxychloride, and zirconium hydroxychloride.

It is preferable to use, as the water-soluble metal compound, at least one selected from the aluminum salts and zirconium salts mentioned above, since superior ink-bleeding resisting effect can be obtained.

The aluminum salt may be polyaluminum chloride. The use of polyaluminum chloride can improve water resistance, weather resistance and bleeding resistance of the ink-receiving layer and prevent the layer from cracking.

The weight-average molecular weight of the polyaluminum chloride is preferably 500 or more, and more preferably from about 1000 to about 100,000.

The content of the polyaluminum chloride is preferably from 1 to 100%, and more preferably from 3 to 50% by mass with respect to the total of the gas-phase process silica in the invention and other inorganic material fine particles optionally contained.

In addition, a water-soluble metal compound which is stable in an acidic liquid is preferably added to the first coating solution, and a water-soluble metal compound which is stable under in an alkaline liquid (e.g. ammonium zinc acetate, ammonium zinc carbonate, ammonium zirconium carbonate, ammonium zirconium nitrate, potassium zirconium carbonate, or ammonium zirconium citrate) is preferably added to the second coating solution.

In the case where the water-soluble metal compound (particularly polyaluminum chloride) is put in an airtight mixing-container (in-line mixer), a solution for the in-line addition is preferably prepared by dissolving or dispersing the water-soluble metal compound in a solvent mainly including water so as to set the concentration of this compound in the resultant solution or dispersion to a value in the range of about 2 to 20% by mass. According to this concentration, the flow rate of the solution is set, and a predetermined amount of the water-soluble metal compound is added to a predetermined amount of the coating solution, which is controlled with a flow rate meter.

As the solvent mainly including water, water, an organic solvent or a mixed solvent thereof can be used. The organic solvent which can be used here is preferably a solvent well compatible with water, such as alcohol such as methanol, ethanol, n-propanol, iso-propanol, methylolpropane, diethylene glycol, triethylene glycol, glycerin, ethylene glycol, propylene glycol, 3,6-dithione-1,8-octanediol and/or methoxypropanol, ketone such as acetone or methyl ethyl ketone, tetrahydrofuran, acetonitrile, and/or pyrrolidone.

In the invention, a part or the whole of the water-soluble metal compound may be added in line. The ratio of the amount of the water-soluble metal compound added in line to that of the water-soluble metal compound added in other manner depends on the kinds of the gas-phase process silica in the invention and optional other inorganic material fine particles, the contents thereof in the coating solution, the kind of the water-soluble metal compound (particularly polyaluminum chloride), and the addition amount thereof. Accordingly, the ratio cannot be clearly determined. However, the ratio can be experimentally obtained from the viewpoint of prevention of the coating solution containing the gas-phase process silica in the invention and optional other inorganic material fine particles from aggregating with the passage of time.

The concentration of sulfate ions contained in the water-soluble metal compound (particularly polyaluminum chloride) is preferably 0.5% or less, more preferably 0.3% or less, and still more preferably 0.1% or less by mass. In order to prevent the silica and optional other fine particles from aggregating and avoid an increase in the viscosity of the coating solution, it is preferable to adjust the concentration of sulfate ions contained in the water-soluble metal compound to 0.5% or less by mass in preparation of the ink-receiving layer coating solution containing a dispersion liquid including the gas-phase process silica in the invention and optional other inorganic material fine particles.

The sulfate ions are derived from raw materials or a stabilizer used to prepare the water-soluble metal compound (particularly polyaluminum chloride), and remain in the water-soluble metal compound. It is therefore preferable that the water-soluble metal compound is produced under such conditions that the amount of the sulfate ions is as small as possible.

In the specification, the sulfate ion concentration is obtained by measuring the mass of a solution sample of the water-soluble metal compound, removing water content therefrom at 100° C., burning the residual at 1450° C. so as to obtain a SO₄ infrared absorption spectrum thereof, and then determining the ion concentration quantitatively from the spectrum. A device for measuring the concentration may be a sulfur analyzer (product name: EMIA-120 model) manufactured by Horiba Ltd.

The method for preparing the dispersion containing the water-soluble metal compound may be a method in which the gas-phase process silica in the invention, optional other inorganic material fine particles and the water-soluble metal compound are added to a solvent (the content of the gas-phase process silica in the solvent being preferably 10 to 20% by mass), and the resultant mixture is stirred with, for example, a disperser (product name: KDL-PILOT) manufactured by Shinmaru Enterprises Corporation.

At this time, any of the compounds exemplified as the above-mentioned organic cationic resin may be used as a dispersing agent for the gas-phase process silica in the invention and optional other inorganic material fine particles. The I/O value of the cationic resin serving as the dispersing agent is preferably 3.0 or less, more preferably 2.7 or less, and still more preferably 2.5 or less in order to improve bleeding resistance of the ink-receiving layer after an image is printed thereon. In this context, the I/O value is a parameter representing an index of balance between the hydrophilicity of a compound or a substituent and the lipophilicity thereof, and is explained in detail in “Organic Conception Diagram” written by Yoshio Kohda (published in 1984 by Sankyo Shuppan Co., Ltd.). The symbol “I” represents inorganicity and the symbol “O” represents organicity. The larger the I/O value of a compound, the higher the inorganicity thereof (the polarity and hydrophilicity thereof becoming higher). Organic cationic resins having different I/O values may be used together.

The dispersion liquid of the gas-phase process silica in the invention, optional other inorganic fine particles and the water-soluble metal compound may be prepared by preparing a dispersion liquid containing the silica and optional fine particles and then adding the dispersion liquid to a solution of the water-soluble metal compound; by adding a solution of the water-soluble metal compound to a dispersion liquid containing the gas-phase process silica and the optional fine particles; or by mixing these components simultaneously. The silica and the optional fine particles may be added to the solution of the water-soluble metal compound not in a form of a dispersion liquid but in a form of powder.

A minute particle dispersion of the gas-phase process silica in the invention, optional other fine particles, and the water-soluble metal compound can be prepared by mixing the silica, the optional inorganic material fine particles, the cationic resin, and the water-soluble metal compound, and stirring the resultant mixture with a disperser to fine the particles in the mixture.

A mixing/dispersing machine used to obtain the dispersion may be any selected from various known dispersers such as a high-speed rotary disperser, medium stirring type dispersers (such as a ball mill and a sand mill), an ultrasonic disperser, a colloid mill disperser, and a high-pressure disperser. In order to effectively disperse formed lumpy fine particles, a medium stirring type disperser, colloid mill disperser, and/or high-pressure disperser is preferable.

The total amount of the water-soluble metal compound contained in the ink-receiving layer in the invention is preferably from 0.5 to 10 g/m², and more preferably from 0.7 to 4 g/m².

—Water-Soluble Sulfur Compound—

It is preferable that the ink-jet recording medium of the invention includes, in its ink-receiving layer, a water-soluble sulfur compound. The water-soluble sulfur compound in the ink-receiving layer can restrain discoloration of images formed in the layer caused by ozone gas (that is, improve the ozone resistance of the layer).

The water-soluble sulfur compound is preferably a compound represented by formula (1) or (2):
X—Y—S—CH₂—CH₂—S—Y—X Formula (1)
X—Y—S—S—Y—X Formula (2)
In the formulae, Xs each independently represent a hydroxyl group, a carboxyl group, a carboxylic acid salt, an acyl group, an amino group, a thiocarbamoyl group, a sulfamoyl group or a sulfoamino group, and Ys each independently represent an alkylene group which may have a substituent.

Examples of the carboxylic acid salt include sodium, potassium and ammonium salts of the acid. The sodium salt and/or ammonium salt is preferable.

The acyl group is represented by “R—CO—”. R may be an alkyl group having 1 to 7 carbon atoms, or a hydrogen atom, and is preferably an alkyl group having 1 to 3 carbon atoms, or a hydrogen atom. Specific examples of the acyl group include formyl, acetyl, propionyl and butyryl groups.

In the formulae, X is preferably a hydroxyl group, a carboxyl group, a carboxylate, or an amino group, and more preferably a hydroxyl or carboxyl group.

In formulae (1) and (2), Ys each independently represent an alkylene group which may have a substituent. The number of carbon atoms contained in the alkylene group is preferably from 1 to 10, and more preferably from 1 to 5.

Examples of the substituent include alkyl groups; halogen atoms such as fluorine, chlorine, bromine, and iodine atoms; a hydroxyl group; alkoxy groups such as methoxy and ethoxy groups; a carboxyl group and salts thereof; acyl groups: nitrogen-containing groups such as amino, methylamino, dimethylamino, hydroxyamino, acetoamide, carbamoyl, oxamoyl and cyano groups; sulfur-containing groups such as thiocyanate, thioformyl, thioacetyl, methylthio, methylsulfonyl and methylsulfinyl groups; a thiocarbamoyl group; a sulfamoyl group; and a sulfoamino group. The substituent is preferably a hydroxyl group, a carboxyl group, a carboxylate group, or an amino group.

The word “water-soluble” of the water-soluble sulfur compound used in the invention means that the sulfur compound is dissolved in water at a ratio of 1% by mass or more. If a compound dissolved in water at a ratio of less than 1% by mass is used instead of the water-soluble sulfur compound, the compound is not easily dissolved in the coating solution for an ink-receiving layer, and is added as an emulsion and glossiness of the recording medium may therefore lower. Meanwhile, the water-soluble sulfur compound can be easily dissolved in the coating solution and glossiness of the recording medium can be improved.

The molecular weight of the compounds represented by formulae (1) and (2) is preferably 180 or more, more preferably from 200 to 500, and still more preferably from 200 to 350. When the ink-jet recording medium of the invention includes a water-soluble sulfur compound having a molecular weight of 180 or more, bleeding of the medium with the passage of time can be sufficiently suppressed.

It is sufficient that the ink-jet recording medium of the invention includes at least one of the compounds represented by formulae (1) and (2). One compound represented by formula (1) or (2) may be used alone or two or more compounds represented by formula (1) or (2) may be used together, or the compound(s) represented by formula (1) may be used together with the compound(s) represented by formula (2). In the case where the compound(s) [x] represented by formula (1) is used together with the compound(s) [y] represented by formula (2), the mass ratio of the compound(s) [x] and the compound(s) [y] is not particularly limited, but is preferably from 1:10 to 10:1, and more preferably from 1:5 to 5:1. The total amount of the compounds represented by formulae (1) and (2) and contained in the ink-receiving layer is preferably from 0.1 to 10 g/m², and more preferably from 0.5 to 5 g/m². When the total amount is within the range of 0.1 to 10/m², sufficient ozone resistance can be given to the ink-receiving layer. Additionally, when the ink-jet recording medium is stored at a low temperature (for example, when it is stored at 5° C. for one week), it is possible to restrain the water-soluble sulfur compound from precipitating on the surface of the ink-jet recording medium or restrain the density of images printed thereon from lowering.

Specific examples of the water-soluble sulfur compound are shown below (compounds A to F). In the invention, however, the water-soluble sulfur compound is not limited to these examples. 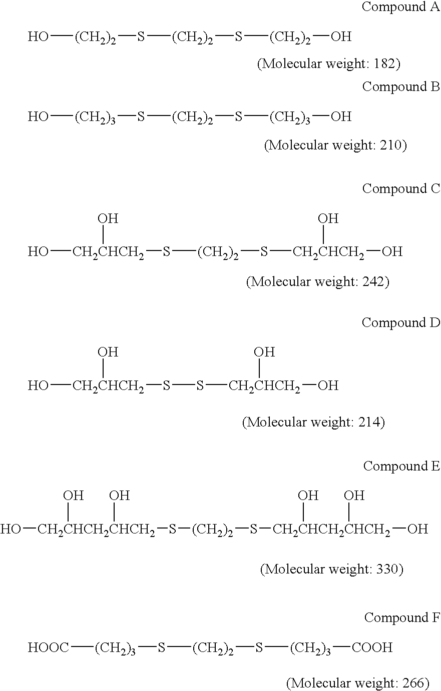
—Surfactant—

In the invention, it is preferable that the ink-receiving layer further contains a surfactant. The surfactant can be a nonionic, amphoteric, anionic, cationic, fluorinated and/or silicon-containing surfactant.

Examples of the nonionic surfactant include polyoxyalkylene alkyl ethers and polyoxyalkylene alkyl phenyl ethers (such as diethylene glycol monoethyl ether, diethylene glycol diethyl ether, polyoxyethylene lauryl ether, polyoxyethylene stearyl ether and polyoxyethylene nonyl phenyl ether), oxyethylene/oxypropylene block copolymer, sorbitan aliphatic acid esters (such as sorbitan monolaurate, sorbitan monooleate, and sorbitan trioleate), polyoxyethylene sorbitan aliphatic acid esters (such as polyethylene sorbitan monolaurate, polyoxyethylene sorbitan monooleate, and polyoxyethylene sorbitan trioleate), polyoxyethylene sorbitol aliphatic acid esters (such as polyoxyethylene sorbit tetraoleate), glycerin aliphatic acid esters (such as glycerol monooleate), polyoxyethylene glycerin aliphatic acid esters (such as polyoxyethylene glycerin monostearate, and polyoxyethylene glycerin monooleate), polyoxyethylene aliphatic acid esters (such as polyethylene glycol monolaurate and polyethylene glycol monooleate), polyoxyethylene alkylamine, acetylene glycols (such as 2,4,7,9-tetramethyl-5-decyne-4,7-diol and an ethylene oxide adduct of the diol, and propylene oxide adduct thereof). The nonionic surfactant is preferably polyoxyalkylene alkyl ether. The nonionic surfactant can be contained in the first coating solution and/or the second coating solution. Moreover, one of the nonionic surfactants may be used alone or two or more of them can be used together. The HLB value of the nonionic surfactant is preferably from 9 to 20, and more preferably from 10 to 18.

Examples of the amphoteric surfactant include those of amino acid type, carboxy ammonium betaine type, sulfone ammonium betaine type, ammonium sulfate betaine type and imidazolium betaine type. For example, surfactants described in U.S. Pat. No. 3,843,368, JP-A Nos. 59-49535, 63-236546, 5-303205, 8-262742, 10-282619, JP Patent Nos. 2514194, and 2759795 and JP-A No. 2000-351269 can be preferably used as such. The amphoteric surfactant is preferably at least one of amino acid type, carboxy ammonium betaine type and sulfone ammonium betaine type. One of the amphoteric surfactants may be used alone, or two or more of them can be used together.

Examples of the anionic surfactant include aliphatic acid salts (for example, sodium stearate and potassium oleate), alkyl sulfates (for example, sodium laurylsulfate and lauryl sulfate triethanolamine), sulfonates (for example, sodium dodecylbenzenesulfonate), alkylsulfosuccinates (for example, sodium dioctylsulfosuccinate), alkyl diphenyl ether disulfonates, and alkyl phosphates.

Examples of the cationic surfactant include alkylamine salts, quaternary ammonium salts, pyridinium salts, and imidazolium salts.

Examples of the fluorinated surfactant include compounds derived, via intermediates having a perfluoroalkyl group, in accordance with electrolytic fluorinating treatment, telomerization, and/or oligomerization.

Examples thereof include perfluoroalkylsulfonates, perfluoroalkylcarboxylates, perfluoroalkylethylene oxide adducts, perfluoroalkyltrialkylammonium salts, perfluoroalkyl group-containing oligomers, and perfluoroalkylphosphates.

The silicon-containing surfactant is preferably silicone oil modified with an organic functional group. Examples thereof include silicone oil wherein side chains of its siloxane main chain structure have been modified with organic groups; silicone oils wherein both terminals thereof have been modified; and silicone oils wherein a single terminal thereof has been modified. Examples of the organic function group for the modification include amino, polyether, epoxy, carboxyl, carbinol, alkyl, aralkyl and phenol groups. The silicone oil modified with fluorine is also contained in the scope of the above silicon-containing surfactant.

The content of the surfactant is preferably 0.01 to 2.0%, and more preferably 0.01 to 1.0% relative to the coating liquid for an ink receiving layer. When at least two coating liquids for an ink receiving layer are used for coating, it is preferable to add a surfactant to respective coating liquids.

The surfactant(s) used in the invention preferably includes the amphoteric surfactant. The use of the amphoteric surfactant further improves developing density.

Other surfactant can be used together with the amphoteric surfactant.

The ink-receiving layer preferably contains a mordant in order to improve water resistance of images formed therein and resistance thereof to bleeding with the passage of time.

The mordant in the ink-receiving layer can interact with liquid ink having an anionic dye as a colorant to stabilize the colorant and further improve water resistance and resistance to bleeding with the passage of time. As the mordant, the above-mentioned cationic resin can be preferably used. The following mordant can also be used.

The mordant may be an organic mordant, and is preferably, for example, a cationic mordant. The cationic mordant is preferably a polymer mordant having, as a cationic group, a primary, secondary or tertiary amino group or a quaternary ammonium salt group, but may be a cationic non-polymer mordant.

The polymer mordant is preferably a homopolymer made from a monomer having a primary, secondary, or tertiary amino group or a salt thereof, or a quaternary ammonium salt group (i.e., a mordant monomer), or a copolymer or a condensed polymer made from the mordant monomer(s) and other monomer(s) (hereinafter, referred to as a “non-mordant monomer(s)”). The polymer mordant may be used in a form of a water-soluble polymer or water-dispersible latex particles.

Examples of the above-mentioned monomer (mordant monomer) include trimethyl-p-vinylbenzylammonium chloride, trimethyl-m-vinylbenzylammonium chloride, triethyl-p-vinylbenzylammonium chloride, triethyl-m-vinylbenzylammonium chloride, N,N-dimethyl-N-ethyl-N-p-vinylbenzylammonium chloride, N,N-diethyl-N-methyl-N-p-vinylbenzylammonium chloride, N,N-dimethyl-N-n-propyl-N-p-vinylbenzylammonium chloride, N,N-dimethyl-N-n-octyl-N-p-vinylbenzylammonium chloride, N,N-dimethyl-N-benzyl-N-p-vinylbenzylammonium chloride, N,N-diethyl-N-benzyl-N-p-vinylbenzylammonium chloride, N,N-dimethyl-N-(4-methyl)benzyl-N-p-vinylbenzylammonium chloride, N,N-dimethyl-N-phenyl-N-p-vinylbenzylammonium chloride, trimethyl-p-vinylbenzylammonium bromide, trimethyl-m-vinylbenzylammonium bromide, trimethyl-p-vinylbenzylammonium sulfonate, trimethyl-m-vinylbenzylammonium sulfonate, trimethyl-p-vinylbenzylammonium acetate, trimethyl-m-vinylbenzylammonium acetate, N,N,N-triethyl-N-2-(4-vinylphenyl)ethylammonium chloride, N,N,N-triethyl-N-2-(3-vinylphenyl)ethylammonium chloride, N,N-diethyl-N-methyl-N-2-(4-vinylphenyl)ethylammonium chloride, N,N-diethyl-N-methyl-N-2-(4-vinylphenyl)ethylammonium acetate, quaternary salts such as methylchloride, ethylchloride, methylbromide, ethylbromide, methyliodide or ethyliodide of N,N-dimethylaminoethyl(meth)acrylate, N,N-diethylaminoethyl(meth)acrylate, N,N-dimethylaminopropyl(meth)acrylate, N,N-diethylaminopropyl(meth)acrylate, N,N-dimethylaminoethyl(meth)acrylamide, N,N-diethylaminoethyl(meth)acrylamide, N,N-dimethylaminopropyl(meth)acrylamide and N,N-diethylaminopropyl(meth)acrylamide, and sulfonates, alkylsulfonates, acetates, and alkylcarboxylates obtained by substituting the anions of these quaternary salts.

Specific examples thereof include monomethyl diallyl ammonium chloride, trimethyl-2-(methacryloyloxy)ethyl ammonium chloride, triethyl-2-(methacryloyloxy)ethyl ammonium chloride, trimethyl-2-(acryloyloxy)ethyl ammonium chloride, triethyl-2-(acryloyloxy)ethyl ammonium chloride, trimethyl-3-(methacryloyloxy)propyl ammonium chloride, triethyl-3-(methacryloyloxy)propyl ammonium chloride, trimethyl-2-(methacryloylamino)ethyl ammonium chloride, triethyl-2-(methacryloylamino)ethyl ammonium chloride, trimethyl-2-(acryloylamino)ethyl ammonium chloride, triethyl-2-(acryloylamino)ethyl ammonium chloride, trimethyl-3-(methacryloylamino)propyl ammonium chloride, triethyl-3-(methacryloylamino)propyl ammonium chloride, trimethyl-3-(acryloylamino)propyl ammonium chloride, triethyl-3-(acryloylamino)propyl ammonium chloride, N,N-dimethyl-N-ethyl-2-(methacryloyloxy)ethyl ammonium chloride, N,N-diethyl-N-methyl-2-(methacryloyloxy)ethyl ammonium chloride, N,N-dimethyl-N-ethyl-3-(acryloyloxy)propyl ammonium chloride, trimethyl-2-(methacryloyloxy)ethyl ammonium bromide, trimethyl-3-(acryloylamino)propyl ammonium bromide, trimethyl-2-(methacryloyloxy)ethyl ammonium sulfonate, and trimethyl-3-(acryloylamino)propyl ammonium acetate.

Examples of the monomer which can be copolymerized include N-vinylimidazole, and N-vinyl-2-methylimidazole.

The non-mordant monomer is a monomer which does not contain any primary, secondary, or tertiary amino group or salt thereof, or which does not contain any basic or cationic moiety such as a quaternary ammonium salt group and which does not interact with any dye contained in an ink-jet ink or show a substantially small interaction with the dye.

Examples of the non-mordant monomer include alkyl(meth)acrylates; cycloalkyl(meth)acrylates such as cyclohexyl(meth)acrylate; aryl(meth)acrylates such as phenyl(meth)acrylate; aralkyl(meth)acrylates such as benzyl(meth)acrylate; aromatic vinyl compounds such as styrene, vinyl toluene, and α-methylstyrene; vinyl esters such as vinyl acetate, vinyl propionate, and vinyl versatate; allyl esters such as allyl acetate; halogen-containing monomers such as vinylidene chloride, and vinyl chloride; vinyl cyanides such as (meth)acrylonitrile; and olefins such as ethylene and propylene.

The alkyl(meth)acrylate ester preferably has an alkyl part having 1 to 18 carbon atoms, and examples thereof include methyl(meth)acrylate, ethyl(meth)acrylate, propyl(meth)acrylate, isopropyl(meth)acrylate, n-butyl(meth)acryalte, isobutyl(meth)acrylate, t-butyl(meth)acrylate, hexyl(meth)acrylate, octyl(meth)acrylate, 2-ethylhexyl(meth)acrylate, lauryl(meth)acrylate, and stearyl(meth)acrylate.

Inter alia, methyl acrylate, ethyl acrylate, methyl methacrylate, ethyl methacrylate, and hydroxyethyl methacrylate are preferable.

One of the non-mordant monomers may be used alone, or two or more of them may be used together.

Typical examples of the polymer mordant include polydiallyl dimethyl ammonium chloride, polymethacryloyloxyethyl-β-hydroxyethyl dimethyl ammonium chloride, polyethyleneimine, polyallylamine and modified products thereof, polyallylamine hydrochloride, polyamide-polyamine resin, cationized starch, dicyandiamide-formalin condensates, dimethyl-2-hydroxypropylammonium salt polymer, polyamidine, polyvinylamine, and cationic polyurethane resin described JP-A No. 10-86505.

The modified polyallylamine can be polyallylamine to which 2 to 50% by mole of acrylonitrile, chloromethylstyrene, TEMPO, epoxyhexane, and/or sorbic acid has been added. It is preferably polyallylamine to which 5 to 10% by mole of acrylonitrile, chloromethylstyrene and/or TEMPO has been added. From the viewpoint of the ozone fading property preventing effect, polyallylamine to which 5 to 10% by mole of TEMPO has been added is particularly preferable.

The weight-average molecular weight of the mordant is preferably from 2,000 to 300,000, more preferably from 3,000 to 10,000, and most preferably from 4,000 to 50,000. When the molecular weight ranges from 2,000 to 300,000, water resistance and resistance to bleeding with the passage of time can be improved.

The amount of the mordant contained in the ink-receiving layer in the invention is preferably from 0.01 to 5 g/m², and more preferably from 0.1 to 3 g/m².

The mordant is added to the first coating solution or the second coating solution, considering the stability of the solution. For example, if the addition of the organic cationic mordant to the first coating solution containing the gas-phase process silica may cause aggregation between the mordant and the gas-phase process silica, which has an anionic charge, the mordant is preferably added to the second coating solution.

—Other Components—

The ink receiving layer preferably contains a high boiling point organic solvent to prevent curling. The high boiling point organic solvent is an organic compound having a boiling point of 150° C. or more at an atmospheric pressure, and a water soluble or hydrophobic compound. The solvent may be a solid or liquid at room temperature, and may be a low molecular weight or high molecular weight compound.

Examples of the organic solvent include aromatic carboxylic acid esters (such as dibutyl phthalate, diphenyl phthalate and phenyl benzoate); aliphatic carboxylic acid esters (such as dioctyl adipate, dibutyl sebacate, methyl stearate, dibutyl maleate, dibutyl fumarate and triethyl acetylcitrate); phosphoric acid esters (such as trioctyl phosphate and tricresyl phosphate); epoxy compounds (such as epoxylated soy bean oil and epoxylated fatty acid methyl esters); alcohols (such as stearyl alcohol, ethylene glycol, propylene glycol, diethylene glycol, triethylene glycol, glycerin, diethylene glycol monobutyl ether (DEGMBE), triethylene glycol monobutyl ether, glycerin monomethyl ether, 1,2,3-butanetriol, 1,2,4-butanetriol, 1,2,4-pentanetriol, 1,2,6-hexanetriol, thiodiglycol, triethanolamine and polyethyleneglycol); vegetable oils (such as soy bean oil and sunflower oil); and higher aliphatic carboxylic acid (such as linoleic acid and oleic acid). The high boiling point organic solvent is preferably diethylene glycol monobutyl ether (DEGMBE).

When an ozone discoloration inhibitor such as thiourea or a thiocyanate is incorporated into the ink-receiving layer of the ink-jet recording medium of the invention, ozone discoloration can be prevented.

Examples of the thiocyanate include ammonium thiocyanate, zinc thiocyanate, calcium thiocyanate, potassium thiocyanate, sodium thiocyanate, magnesium thiocyanate, aluminum thiocyanate, lithium thiocyanate, silver thiocyanate, chloromethyl thiocyanate, cobalt thiocyanate, copper thiocyanate, lead thiocyanate, barium thiocyanate, and benzyl thiocyanate. One of thioureas and thiocyanates may be used alone, or two or more of them can be used together.

In the invention, thiourea or thiocyanates may be added to the first or second coating solution. It is preferable from the viewpoint of solution stability to add the ozone discoloration inhibitor(s) to the second coating solution and incorporate it into the ink-receiving layer. The content of thiourea or thiocyanate contained in the ink-receiving layer is preferably from 1 to 20% by mass, and more preferably from 2 to 10% by mass. When the content ranges from 1 to 20% by mass, resistance to ozone discoloration can be more satisfactorily exhibited and the ink-receiving layer can be restrained from cracking.

In the invention, the ink-receiving layer may contain any ultraviolet absorbent, antioxidant, and/or color fading inhibitor such as a singlet oxygen quencher in order to restrain the colorant contained in the layer from deteriorating.

Examples of the ultraviolet absorbent include cinnamic acid derivatives, benzophenone derivatives, and benzotriazoylphenol derivatives. Specific examples thereof include butyl α-cyano-phenylcinnmate, o-benzotriazolephenol, o-benzotriazole-p-chlorophenol, o-benzotriazole-2,4-d-t-butylphenol, and o-benzotriazole-2,4-d-t-octylphenol. A hindered phenol compound may also be used as the ultraviolet absorbent. Specifically, the compound is preferably a phenol derivative having as at least one substituent one or more branched alkyl groups at the 2-position or the 6-position.

Alternatively, a benzotriazole ultraviolet absorbent, a salicylic acid ultraviolet absorbent, a cyanoacrylate ultraviolet absorbent, and/or an oxalic acid anilide ultraviolet absorbent may be used. Those ultraviolet absorbents are described, for example, in JP-A Nos.47-10537, 58-111942, 58-212844, 59-19945, 59-46646, 59-109055, and 63-53544, Japanese Patent Application Publication (JP-B) Nos. 36-10466, 42-26187, 48-30492, 48-31255, 48-41572, 48-54965, and 50-10726, and U.S. Pat. Nos. 2,719,086, 3,707,375, 3,754,919, and 4,220,711.

A fluorescent brightener may be used as an ultraviolet absorbent, and can be a coumarin fluorescent brightener. Specifically, those agents are described in JP-B Nos. 45-4699, and 54-5324.

Examples of the antioxidant include EP Nos. 223739, 309401, 309402, 310551, 310552 and 459416, DE-A No.3435443, and JP-A Nos. 54-48535, 60-107384, 60-107383, 60-125470, 60-125471, 60-125472, 60-287485, 60-287486, 60-287487, 60-287488, 61-160287, 61-185483, 61-211079, 62-146678, 62-146680, 62-146679, 62-282885, 62-262047, 63-051174, 63-89877, 63-88380, 63-88381, 63-113536, 63-163351, 63-203372, 63-224989, 63-251282, 63-267594, 63-182484, 1-239282, 2-262654, 2-71262, 3-121449, 4-291685, 4-291684, 5-61166, 5-119449, 5-188687, 5-188686, 5-110490, 5-1108437, and 5-170361, JP-B Nos. 48-43295, and 48-33212, and U.S. Pat. Nos. 4,814,262, and 4,980,275.

Specifically, examples thereof include 6-ethoxy-1-phenyl-2,2,4-trimethyl-1,2-dihydroquinoline, 6-ethoxy-1-octyl-2,2,4-trimethyl-1,2-dihydroquinoline, 6-ethoxy-1-phenyl-2,2,4-trimethyl-1,2,3,4-tetrahydroquninoline, 6-ethoxy-1-octyl-2,2,4-trimethyl-1,2,3,4-tetrahydroquinoline, nickel cyclohexanoate, 2,2-bis(4-hydroxyphenyl)propane, 1,1-bis(4-hydroxyphenyl)-2-ethylhexane, 2-methyl-4-methoxy-diphenylamine, and 1-methyl-2-phenylindole.

One of the color fading inhibitors may be used alone, or two or more of them may be used together. This color fading inhibitor may be water-solubilized, dispersed or emulsified or may be contained in microcapsules.

The content of the color fading inhibitor is preferably 0.01 to 10% by mass of the first coating solution.

The ink-receiving layer may contain any inorganic salt in order to improve dispersibility of the gas-phase process silica in the invention and optional other inorganic material fine particles, and may contain a pH adjusting agent such as an acid or a base in order to adjust the film surface pH of the ink-receiving layer. The film surface pH is preferably from 2 to 7, and more preferably from 3 to 5.

The ink-receiving layer may contain electrically conductive metal oxide fine particles to suppress friction charging or exfoliation charging of the surface, or may contain a matting agent to decrease the frictional properties of the surface.

<Method for Forming Ink-Receiving Layer>

A method for forming an ink-receiving layer will be explained hereinafter.

The ink-receiving layer in the ink-jet recording medium of the invention is preferably formed by cross-linking and hardening a coating layer obtained by applying the first coating solution including the gas-phase process silica in the invention and the water-soluble resin. The cross-linking and hardening are preferably carried out by supplying a solution containing a metal compound and having a pH of 7.1 or more (i.e., a second coating solution) to a coating layer formed by applying the first coating solution (1) simultaneously with the first coating solution being applied, (2) before the coating layer exhibits a decreasing rate of drying at the time that the coating layer is dried, or (3) after the coating layer is dried to form a dry coating film.

In the invention, a coating solution including the gas-phase process silica in the invention, the cationic resin, boric acid, and a nonionic or amphoteric surfactant and a high boiling point solvent (i.e., an ink-receiving layer coating solution) can be prepared as follows.

The gas-phase process silica in the invention is added to water, and the cationic resin is added to the resultant. The silica is dispersed in water with a high-pressure homogenizer, or a sand mill. Thereafter, boric acid is added to the resultant dispersion. An aqueous solution of polyvinyl alcohol is added to the dispersion such that the mass of polyvinyl alcohol is, for example, about ⅓ of that of the gas-phase process silica. Furthermore, the nonionic or amphoteric surfactant and the high boiling point solvent are added to the dispersion, and then the resultant is stirred. A coating solution can be thus prepared. The resultant coating solution is homogeneous sol, and is applied to a support in accordance with a coating method described later. In this way, the ink-receiving layer, which has a porous three-dimensional network structure, can be formed.

By adding polyvinyl alcohol to the dispersion after the dilution of boric acid as described above, polyvinyl alcohol can be prevented from partially gelatinizing.

In the invention, it is preferable that the first coating solution is an acidic solution. pH of the coating solution is preferably 5.0 or lower, more preferably 4.5 or lower, and still more preferably 4.0 or lower. pH of the coating solution can be adjusted by appropriately selecting the kind and the addition amount of the cationic resin. Alternatively, pH may be adjusted by adding an organic or inorganic acid to the first coating solution. When pH of the coating solution is 5.0 or lower, a cross-linking reaction of an aqueous resin in a coating solution caused by a boron compound can be more sufficiently suppressed.

The application of the first coating solution may be performed in accordance with a known coating method such as extrusion die coating, air doctor knife coating, bread coating, rod coating, knife coating, squeeze coating, reverse roll coating and/or bar coating.

The application amount of the first coating solution is generally from 50 to 300 g/m², and more preferably from 100 to 250 g/m². pH of the second coating solution is preferably 7.1 or higher, more preferably 7.5 or higher, and still more preferably 8.0 or higher. When pH of the basic solution is lower than 7.1, the ink receiving layer cracks. The pH may be adjusted with a basic metal compound or a basic mordant (e.g. ammonium zirconium carbonate), or other basic substance (sodium hydroxide, potassium hydroxide, calcium hydroxide, ammonia, tetramethyl ammonium hydroxide, ethanolamine, ethylenediamine, or a salt thereof, or both of them. Allkaline colloidal silica, for example, “SNOWTEX® 20, 30, 40, C, N, S, 20L, XS, SS, XL, YL, ZL, UP, QAS-40, or LSS-35” manufactured by Nissan Chemical Industries, Ltd. may be used to adjust pH of the second coating solution.

The same hardener that is contained in the first coating solution may also be added to the second coating solution at pH of 7.1 or higher.

The second coating solution is preferably applied to a coating layer obtained by applying the first costing solution to a support before the coating layer exhibits a decreasing rate of drying.

In this context, the phrase “before the coating layer exhibits a decreasing rate of drying” usually means several minutes immediately after the application of the first coating solution. A constant rate of drying, at which the solvent content in the coating layer decreases in proportion to the passage of time, is exhibited during this period. The time when a constant rate of drying is exhibited is described in Chemical Engineering Handbook” (pp. 707-712, published by Marzen Co., Ltd. in Oct. 25, 1980.

As described above, the coating layer formed by applying the first coating solution to a support is dried until the coating layer exhibits a decreasing rate of drying. The drying is generally performed at a temperature of 40 to 180° C. for a period of 0.5 to 10 minutes (preferably for a period of 0.5 to 5 minutes). This drying time, which depends on the applied amount of the solution, is suitably within the above-mentioned range. The coating layer may be dried by cool wind, as described in JP-A No. 2004-1240.

A method for supplying the second coating solution before the coating layer exhibits a decreasing rate of drying may be a method (1) of applying the second coating solution onto the coating layer, a method (2) of spraying the second solution with a spray, or a method (3) of immersing the support on which the coating layer is formed into the second coating solution.

In the method (1), a known coating apparatus such as a curtain flow coater, an extrusion die coater, an air doctor coater, a bread coater, a rod coater, a knife coater, a squeeze coater, a reverse roll coater, and/or a bar coater can be utilized. However, an extrusion die coater, a curtain flow coater, and/or a bar coater, which is not brought into direct contact with the already formed coated layer.

The application amount of the second coating solution is generally from 5 to 50 g/m², and preferably from 7 to 30 g/m².

Alternatively, the second coating solution and the first coating solution may be applied simultaneously.

In this case, the first coating solution and the second coating solution are simultaneously coated (overlaying coating) on a support so that the first coating solution is brought into contact with the support. Thereafter, the resultant coating layers are dried and hardened, thereby, an ink-receiving layer can be formed.

The simultaneous coating (overlaying coating) can be performed, for example, by a coating method using an extrusion die coater, or a carton flow coater. After simultaneous coating, the formed coating layers are dried. The drying is generally performed by heating the coating layers at a temperature of 40 to 150° C. for a period of 0.5 to 10 minutes, and preferably at a temperature of 40 to 100° C. for a period of 0.5 to 5 minutes.

For example, when a boron compound is used, it is preferable to heat the coating layers at a temperature of 60 to 100° C. for a period of 5 to 20 minutes. The coating layers may be dried with cooling wind, as described in JP-A No. 2004-1240.

When the simultaneous coating (i.e., overlaying coating) is performed with, for example, an extrusion die coater, two coating solutions jetted out at the same time are formed into two overlapping layers near the jetting port of the extrusion die coater (that is, before the two solutions are transferred onto a support) and the two overlapping layers are transferred onto the support. The two coating solutions overlapped before the application thereof to the support easily cause cross-linking reaction in the interface between the two solutions, when the solutions are transferred onto the support. The two solutions jetted out are mixed near the jetting port of the extrusion die coater and the viscosity of the mixture may thereby easily increase. Thereby, application operation may be hindered. Therefore, when the overlaying coating is performed, it is preferable to interpose a barrier layer solution (i.e., an intermediate layer solution) including a material which does not react with the hardener between the first coating solution and the basic solution (i.e., the second coating solution) to perform overlaying coating of the three layers.

The barrier layer solution can be any solution which does not react with the boron compound and which enables formation of liquid films. For example, the barrier layer solution can be an aqueous solution containing a trace amount of a water-soluble resin which does not react with the boron compound, or water. The water-soluble resin is used in view of the coating property for the purpose of thickening, and examples thereof include polymers such as hydroxypropylmethylcellulose, methylcellulose, hydroxyethylmethylcellulose, polyvinylpyrrolidone, and gelatin.

The barrier layer solution may contain the aforementioned mordant.

The solvent used in each of the steps may be water, an organic solvent or a mixed solution thereof. Examples of the organic solvent include alcohols such as methanol, ethanol, n-propanol, iso-propanol and methoxypropanol, ketones such as acetone and methyl ethyl ketone, tetrahydrofuran, acetonitrile, ethyl acetate, and toluene. The solvent is preferably ethanol.

In order to calendar an ink-receiving layer formed on a support, the support may be made to pass through a roll nip of a supercalendar or gloss calendar device while heat and pressure are applied to the support. Thereby, surface smoothness, glossiness, transparency and coated film strength of the ink-receiving layer can be improved. However, since the calendar treatment causes reduction in porosity in some cases (that is, the ink absorbing property deteriorates in some cases), it is necessary to set conditions so that porosity is hardly reduced.

The roll temperature at the time of calendar treatment is preferably 30 to 150° C., and more preferably 40 to 100° C.

In addition, a linear load between rolls at the time of calendar treatment is preferably 50 to 400 kg/cm, and more preferably 100 to 200 kg/cm.

In the case of ink-jet recording, the ink-receiving layer needs to have an absorption volume for absorbing all of received ink droplets. It is therefore necessary that the thickness of the ink-receiving layer be determined in consideration of the porosity of the layer. For example, in a case that the amount of received ink is 8 nL/mm² and the porosity is 60%, it is necessary that the layer have a thickness of about 15 μm or more.

The ink-receiving layer including the gas-phase process silica in the invention has higher ink absorptivity than the ink-receiving layer of any ink-jet recording medium in the prior art. Therefore, the thickness of the ink-receiving layer can be thin while the layer keeps ink absorptivity equal to that in the prior art. The thickness of the ink-receiving layer can be in the range of, for example, 30 to 35 μm, and preferably 25 to 29 μm. In a case that the thickness of the ink-receiving layer is in the range of 30 to 35 μm but constant ink absorptivity is kept as described above, it is possible to produce an ink-jet recording medium which sufficiently absorbs ink from any ink-jet printer for giving photographic image quality (ink-jetting amount of about 20 mL/m²) and does not generate defects such as curling or cracking.

In addition, the median diameter of micropores of the ink-receiving layer is preferably 0.005 to 0.030 μm, and more preferably 0.01 to 0.025 μm.

The porosity and the median diameter of micropores can be measured with a mercury porosimeter (PORESIZER 9320-PC2 manufactured by Simadzu Corporation).

In addition, it is preferable that the-ink receiving layer is excellent in transparency. As its index, the haze value of an ink-receiving layer formed on a transparent film support is preferably 30% or smaller, and more preferably 20% or smaller.

The haze value can be measured with a hazemeter (HGM-2DP manufactured by Suga Test Instrument Co., Ltd.).

<Support>

The support may be any support selected from transparent supports made of a transparent material such as plastic, and opaque supports made of an opaque material such as paper. In order to make use of transparency of the ink-receiving layer, it is preferable to use a transparent support or a highly glossy opaque support.

The support is not limited to paper or a plastic sheet (or film), and may be a read-only optical disk such as a CD-ROM, or a DVD-ROM, a recordable optical disk such as a CD-R or a DVD-R, or a rewritable optical disk. The ink-receiving layer can be supplied onto the information-recording side of the support.

The material which can be used for the transparent support is preferably a transparent material which can resist radiant heat generated when the transparent support is used on an OHP device or a backlight display. Examples of the material include polyesters such as polyethylene terephthalate (PET), polysulfone, polyphenylene oxide, polyimide, polycarbonate, and polyamide. Among these, the material is preferably polyester, and more preferably PET. The transparent support may be colored blue, since the recording medium is used for medical treatment.

The thickness of the transparent support is not particularly limited, but is preferably from 50 to 200 μm from the viewpoint of handling thereof.

In the case of an opaque support having high glossiness, the surface of the support on which surface an ink-receiving layer is provided preferably has glossiness of 40% or larger. The glossiness is obtained according to a method stipulated in JIS P-8142 (test method for a 75 degree specular surface glossiness of paper and board paper.

Examples of such a support include paper supports having high glossiness such as art paper, coated paper, cast coated paper, and RC paper and baryta paper which are used as the support of silver salt photographic materials; films having high glossiness and obtained by adding a white pigment to plastic films including polyesters such as polyethylene terephthalate (PET), cellulose esters such as nitrocellulose, cellulose acetate, cellulose acetate butyrate, polysulfone, polyphenylene oxide, polyimide, polycarbonate, or polyamide whose surface may be calendared) to make the films opaque; and supports in which a covering layer of polyolefin containing or not containing a white pigment is provided on the surface of the paper support, transparent support or film containing a white pigment and having high glossiness.

The highly glossy and opaque support can also be a white pigment-containing expanded polyester film (e.g. expanded PET which contains polyolefin fine particles and voids formed by stretching).

The thickness of the opaque support is not particularly limited, however is preferably 50 to 300 μm from the viewpoint of handling property.

The support may be subjected to corona discharge treatment, glow discharge treatment, flame treatment, and/or ultraviolet-ray illumination treatment.

Hereinafter, the base paper of the paper support will be described in detail.

The base paper is made from wood pulp (main component) and optional synthetic pulp, such as polypropylene pulp, and/or optional synthetic fiber such as nylon or polyester fiber. The wood pulp may be LBKP, LBSP, NBKP, NBSP, LDP, NDP, LUKP and/or NUKP. It is preferable to use a larger amount of LBKP, NBSP, LBSP, NDP and/or LDP, which contains a large amount of short fibers.

The percentage of LBSP and/or LDP is preferably from 10 to 70% by mass.

The pulp is preferably a chemical pulp (sulfate pulp or sulfite pulp) having little impurities, and a pulp, whiteness degree of which has been improved by breaching treatment, is also useful as the pulp.

A sizing agent such as higher fatty acid, or alkyl ketene dimer, a white pigment such as calcium carbonate, talc, or titanium oxide, a paper strength potentiator such as starch, polyacrylamide, or polyvinyl alcohol, a fluorescent brightener, a moisture retaining agent such as polyethylene glycol, a dispersing agent, and/or a softening agent such as quaternary ammonium may be added to the base paper, if necessary.

The freeness, stipulated in CSF, of the pulp used in paper making is preferably 200 to 500 ml. It is preferable that a fiber length after beating is such that the sum of the amounts of a residual which cannot pass through a 24 mesh and a residual which cannot pass through a 42 mesh, stipulated in JIS P8207, is 30 to 70% by mass. In addition, it is preferable that the amount of a residual which cannot pass through a 4 mesh is 20% by mass or smaller.

The weight of the base paper is preferably from 30 to 250 g, and more preferably from 50 to 200 g. The thickness of the base paper is preferably from 40 to 250 μm. The base paper may be calendared during or after paper making thereof so as to provide a high smoothness. The density, measured in accordance with JIS P-8118, of the base paper is generally from 0.7 to 1.2 g/m².

Furthermore, the stiffness of the base paper is preferably from 20 to 200g under conditions specified in JIS P8143.

A surface sizing agent may be applied to the surface of the base paper, and this surface sizing agent may be the same as the sizing agent included in the base paper.

The pH of the base paper is preferably 5 to 9 when measured in accordance with a hot water extraction method stipulated in JIS P8113.

Although the material(s) that may be used to cover the front surface and the back surface of the base paper is low density polyethylene (LDPE) and/or high density polyethylene (HDPE), LLDPE and/or polypropylene may be partly used.

It is preferable that polyethylene covering the surface of the support on which surface an ink-receiving layer is formed contains titanium oxide of rutile or anatase type, which is widely adopted in photographic printing paper, to improve opaqueness and/or whiteness degree. The content of titanium oxide is preferably 3 to 20% by mass, and more preferably 4 to 13% by mass relative to polyethylene.

The paper coated with polyethylene may be used as glossy paper, or have a matted surface or silky surface which is similar to that of ordinary photographic printing paper and which is formed by embossing polyethylene which has been just melt-extruded on the base paper to provide a polyethylene coating.

### EXAMPLES

The invention will be described by way of the following examples. However, the invention is not limited to these examples. The symbol “%” and the word “part(s)” represent “% by mass” and “part(s) by mass”, respectively, unless otherwise specified.

### Example 1

—Production of Support—

A wood pulp made of 100 parts of LBKP was beaten with a double disc-refiner so that the Canadian freeness became 300 mL. 0.5 parts of epoxidized behenic amide, 1.0 part of anionic polyacrylamide, 0.1 part of polyamide polyamine epichlorohydrin, and 0.5 part of cationic polyacrylamide were added to the pulp. These amounts were bone dry masses relative to the mass of the pulp. A Fourdrinier paper machine was used to weight the resultant and make base paper having weight of 170 g/m².

A fluorescent whitener (Whitex BB manufactured by Sumitomo Chemical Co., Ltd.) was added to a 4% aqueous solution of polyvinyl alcohol so that the concentration of the fluorescent whitener was 0.04%. In order to adjust the surface size of the base paper, the base paper was impregnated with this solution so that a layer of the solution having bone dry mass of 0.5 g/m² was formed on the base paper. The base paper was dried and then calendared to yield a substrate sheet having an adjusted density of 1.05 g/mL.

The wire face (rear surface) of the resultant substrate sheet was subjected to corona discharge, and then coated with high-density polyethylene from a melt-extruder to form a resin layer having a thickness of 25 μm and a matted surface (the resin layer surface will be referred to as the “rear surface” hereinafter). The resin layer on the rear surface was subjected to corona discharge. Thereafter, a dispersion liquid in which a combination of aluminum oxide (ALUMINA SOL 100 manufactured by Nissan Chemical Industries, Ltd.) and silicon dioxide (SNOWTEX O manufactured by Nissan Chemical Industries, Ltd.) at a mass ratio of the former to the latter of 1:2 was dispersed in water was applied as an antistatic agent to the resin layer so that the dry mass of the antistatic agent became 0.2 g/m².

Furthermore, the felt face (front surface) of the substrate sheet, on which no resin layer had been formed, was subjected to corona discharge. Thereafter, low density polyethylene containing 10% of anatase-type titanium dioxide, a trace amount of ultramarine blue, and a fluorescent whitener whose amount was 0.01% with respect to the polyethylene, and having a MFR (melt flow rate) of 3.8 was extruded from a melt-extruder onto the front surface so as to form a highly glossy thermoplastic resin layer having a thickness of 22 μm thereon. In this way, a support was produced.

—Production of Gas-Phase Process Silica A—

Gas-phase process silica A (gas-phase process silica in the invention) was produced in accordance with the following method. Ordinary hydrophilic gas-phase process silica (AEROSIL 300 manufactured by Nippon Aerosil Co., Ltd.), which had not been surface-treated, was first treated with dimethyldichlorosilane so as to adjust the silanol group density of the gas-phase process silica A to 2.0 SiOH groups/nm².

—Preparation of Ink-Receiving Layer Coating Solution—

(1) Preparation of Silica Dispersion A

144.1 g of ethanol and 65.5 g of a cationic resin (SHALLOL DC-902P manufactured by Dai-ichi Kogyo Seiyaku Co., Ltd.) serving as a dispersing agent were added to 4000 g of deionized water. Subsequently, 750 g of the gas-phase process silica A was added to the resultant, and then the resultant was stirred with a dissolver at 6000 rpm for 20 minutes. After the stirring, 40.4 g of zirconyl acetate (ZA-30 manufactured by Daichi Kigenso Kagaku Kogyo Co., Ltd.) was added to the resultant dispersion liquid, and the dispersion liquid was stirred with the dissolver at 3500 rpm for five minutes. The resultant dispersion liquid was stirred two times with a Dyno mill (KDP manufactured by Shinmaru Enterprises Corporation) to yield a silica dispersion liquid A. As for physical properties of the resultant silica dispersion liquid A, the viscosity thereof was 220 mPas (30° C.) and the pH was 3.32.

The silica dispersion liquid A was stored at 45° C. for 20 hours to obtain a stable viscosity, and then stored at 23° C.

(2) Preparation of Polyvinyl Alcohol (PVA) Solution A

73.06 kg of deionized water, 0.712 kg of a nonionic surfactant (EMULGEN 109P manufactured by Kao Corp., a 10% aqueous solution), 0.928 g of diethylene glycol monobutyl ether, 0.156 g of N,N′-bis(carbamoylmethyl)ethylenediamine and 5.599 kg of polyvinyl alcohol (PVA235 manufactured by Kuraray Co., Ltd.) were mixed to prepare an aqueous solution. The solution was heated at 90° C. for 60 minutes to yield a PVA solution A. The viscosity of the resultant PVA solution A was 590 mPas (30° C.) and the pH thereof was 4.04.

(3) Preparation of Ink-Receiving Layer Coating Solution

15.3 g of deionized water, an aqueous boric acid solution in which 4.3 g of boric acid was dissolved in 65.86 g of deionized water, and 2.9 g of a cationic resin (SC-505 Hymo Corp.) were added to 754.5 g of the silica dispersion liquid A, and the resultant was stirred at 2000 rpm with a dissolver for 10 minutes. After the stirring,329.6 g of the PVA solution A, and 2.9 g of diethylene glycol monobutyl ether were added to the resultant, and the resultant was stirred at 1400 rpm for 10 minutes. Next, 14.1 g of a water-dispersible urethane polymer (SUPERFLEX 600B manufactured by Dai-ichi Kogyo Seiyaku Co., Ltd.) and 70.4 g of a 40% ethanol solution were added to the resultant, and the resulting mixture was stirred with the dissolver at 1400 rpm for five minutes. Furthermore, 2.1 g of an amphoteric surfactant (AMPHITOL 24B manufactured by Kao Corp.), and 7.0 g of a nonionic surfactant (EMULGEN 109P manufactured by Kao Corp., a 2% aqueous solution) were added to the mixture, and the resultant was stirred with the dissolver at 1400 rpm for five minutes. An ink-receiving layer coating solution A was thus prepared. The ink-receiving layer coating solution A was stored at 30° C. Immediately before application thereof, 62.5 parts of an aqueous solution of polyaluminum chloride (ALFINE 83 manufactured by Taimei Chemicals Co., Ltd.) obtained by diluting a polyaluminum chloride solution with water so that the amount of the diluted solution was 5 times as large as that of the original solution was added to 1000 parts of the ink-receiving layer coating solution A. The resultant was stirred with the dissolver at 1400 rpm for five minutes. This was used as an ink-receiving layer coating solution AA.

As for physical properties of the ink-receiving layer coating solution A, the viscosity was 254 mPas (30° C.), the pH was 3.80, and the surface tension was 41.7 mN/cm.

The viscosity of the ink-receiving layer coating solution AA was 160 mPas (30° C.).

—Preparation of Hardener Solution A—

7.8 g of boric acid, 42.0 g of ammonium carbonate, 30.5 g of zirconium carbonate (ZIRCO SOL AC-7 manufactured by Daichi Kigenso Kagaku Kogyo Co., Ltd.), 68.6 g of hydroxypropylcellulose (HPC-SL manufactured by Nippon Soda Co., Ltd., a 7% aqueous solution) and 240.0 g of a nonionic surfactant (EMULGEN 109P manufactured by Kao Corp., a 2% aqueous solution) were added to 811.1 g of deionized water so as to prepare a hardener solution A.

As for physical properties of the hardener solution A, the viscosity was 1.38 mPas (30° C.), the pH was 8.02, and the surface tension was 31.5 mN/cm.

—Production of Ink-Jet Recording Sheet—

The above-mentioned ink-receiving layer coating solution AA was applied to the front surface of the support with an extrusion die coater at an applying amount of 194.4 g/m². The resultant layer was dried at 70° C. with a hot wind drier (wind velocity: 3 to 8 m/sec.) until the solid concentration in-the coating layer became 20%. The coating layer exhibited constant rate of drying during this period. Immediately after this, the support on which a coating layer was formed was immersed into the hardener coating solution A for five seconds to adhere the solution to the coating layer at an amount of 10 g/m². Thereafter, the resultant was dried at 70° C. for 10 minutes. In this way, an ink-receiving layer having a dry thickness of 34 μm was formed on the support. Thus, an ink-jet recording sheet A of the invention was prepared.

### Example 2

An ink-jet recording sheet of the invention was prepared in the same way as in Example 1 except that “gas-phase process silica B” having a silanol group density of 1.8 [SiOH groups/nm²] was used instead of the “gas-phase process silica A”.

### Example 3

An ink-jet recording sheet of the invention was prepared in the same way as in Example 1 except that “gas-phase process silica C” having a silanol group density of 1.5 [SiOH groups/nm²] was used instead of the “gas-phase process silica A”.

### Example 4

An ink-jet recording sheet of the invention was prepared in the same way as in Example 1 except that “gas-phase process silica D” having a silanol group density of 1.2 [SiOH groups/nm²] was used instead of the “gas-phase process silica A”.

### Example 5

An ink-jet recording sheet of the invention was prepared in the same way as in Example 1 except that the aforementioned sulfur compound A was added to the ink-receiving layer coating solution and except that the application amount of the sulfur compound A was 1 g/m².

### Comparative Example 1

An ink-jet recording sheet was prepared in the same way as in Example 1 except that the “gas-phase process silica A” was replaced with “gas-phase process silica E” (AEROSIL 300 manufactured by Nippon Aerosil Co., Ltd.).

### Comparative Example 2

An ink-jet recording sheet was prepared in the same way as in Example 1 except that the “gas-phase process silica A” was replaced with the following “gas-phase process silica F”.

—Preparation of Gas-Phase Process Silica F—

The gas-phase process silica F was prepared in accordance with the following method. Ordinary hydrophilic gas-phase process silica (AEROSIL 300 manufactured by Nippon Aerosil Co., Ltd.), which had not been surface-treated, was first treated with dimethyldichlorosilane to adjust the silanol group density of the gas-phase process silica F to 0.7 [SiOH groups/nm²].

Evaluation

The following items for the silica fine particles and the inkjet recording sheet of each of Examples and Comparative Examples were evaluated.

—BET Specific Surface Area—

The BET specific surface area of the gas-phase process silica used in each of Examples and Comparative Examples was measured with an automatic BET specific surface area measuring device (SOPTPMATIC SERIES 1800 manufactured by Carlo-Erba Co.). The results are shown Table 1.

—Silanol Group Density—

The silanol group density of the gas-phase process silica used in each of Examples and Comparative Examples was measured in accordance with a lithium aluminum hydride method described in “TECHNICAL BULLETIN AEROSIL NO. 17 “BASIC PERFORMANCE OF AEROSIL” p. 41, Nippon Aerosil Co., Ltd.” The results are shown in Table 1.

—Ink Absorbing Volume—

The ink absorbing volume per m² of each of the ink-jet recording sheets was measured with a mercury porosimeter (PORESIZER 9320-PC2 manufactured by Shimadzu Corp.). The results are shown in Table 1.

—Glossiness—

The 60° glossiness of the ink-receiving layer surface of each of the ink-jet recording sheets was measured with a digital angle-variable glossmeter (UGV-50DP manufactured by Suga Test Instruments Co., Ltd.). The results are shown in Table 1.

—Ink Absorptivity—

Solid images were printed on the ink-receiving layer surface of each of the ink-jet recording sheets with yellow (Y), magenta (M), cyan (C), black (K), blue (B), green (G) and red (R) inks and an ink-jet printer (PM-G800 manufactured by Seiko Epson Corp.). Immediately after the printing (about 10 seconds later), a sheet of paper was pressed against the image-printed surface. A check was made with the naked eyes to determine whether or not the inks were transferred onto the sheet of paper. In accordance with the following criterion, the ink absorptivity of each ink-jet recording sheet was evaluated. The results are shown in Table 1.

Criterion

◯: None of the inks was transferred onto the sheet of paper.

×: A large amount of the inks were transferred onto the sheet of paper.

—Beading—

Yellow (Y), magenta (M), cyan (C), black (K), blue (B), green (G) and red (R) solid images were printed on the ink-receiving layer surface of each of the ink-jet recording sheets with an ink-jet printer (PM-G800 manufactured by Seiko Epson Corp.). The degree of generation of color unevenness in the form of beads (i.e., beading) in the resultant images was checked with the naked eyes, and evaluated in accordance with the following criterion. The results are shown in Table 1.

Criterion

◯: No generation of beading was observed.

×: Beading remarkably occurred.

—Bronze Glossiness—

A blue (B) solid image was printed on the ink-receiving layer surface of each of the ink-jet recording sheets with an ink-jet printer (PM-G800 manufactured by Seiko Epson Corp.). The degree of generation of bronze glossiness in the resultant image was checked with the naked eyes, and evaluated in accordance with the following criterion. The results are shown in Table 1.

Criterion

◯: No generation of bronze glossiness was observed.

×: Bronze glossiness remarkably occurred.

—Visual Density—

A black (K) solid image was printed on the ink-receiving layer surface of each of the ink-jet recording sheets with an ink-jet printer (PM-G800 manufactured by Seiko Epson Corp.). After the printing, each of the sheets was allowed to stand for three hours, and then the visual density (black Dm) of the image was measured with a visual densitometer (X RITE 310TR manufactured by X-Rite Inc.). The results are shown in Table 1.

—Ozone Resistance—

A magenta (M) solid image was printed on the ink-receiving layer surface of each of the ink-jet recording sheets with an ink-jet printer (PM-G800 manufactured by Seiko Epson Corp.). After the printing, each of the sheets was stored in an environment having an ozone concentration of 5 ppm for 16 hours. The magenta density (D₀) of the image before the storing and the magenta density (D₁) thereof after the storing were measured with a reflection densitometer (X RITE 93 manufactured by X-Rite Inc.). The remaining rate of the magenta image was calculated in accordance with the following equation: (D₁ X 100)/D₀.

| | | | | | | Comparative | Comparative |
|---|---|---|---|---|---|---|---|
| | Example 1 | Example 2 | Example 3 | Example 4 | Example 5 | Example 1 | Example 2 |
| Gas-phase | A | B | C | D | A | E | F |
| process silica | | | | | | | |
| BET specific | 302 | 298 | 300 | 305 | 302 | 303 | 300 |
| surface area | | | | | | | |
| (m²/g) | | | | | | | |
| Silanol group | 2.0 | 1.8 | 1.5 | 1.2 | 2.0 | 2.5 | 0.7 |
| density (SiOH | | | | | | | |
| groups/nm²) | | | | | | | |
| Absorbing | 22.0 | 23.0 | 23.0 | 23.8 | 21.9 | 18.2 | 23.0 |
| volume | | | | | | | |
| (ml/m²) | | | | | | | |
| Glossiness | 42% | 40% | 40% | 35% | 41% | 42% | 16% |
| Ink | ◯ | ◯ | ◯ | ◯ | ◯ | X | ◯ |
| absorptivity | | | | | | | |
| Beading | ◯ | ◯ | ◯ | ◯ | ◯ | X | ◯ |
| Bronze | ◯ | ◯ | ◯ | ◯ | ◯ | X | ◯ |
| glossiness | | | | | | | |
| Black Dm | 2.10 | 2.11 | 2.12 | 2.05 | 2.09 | 1.89 | 1.80 |
| Ozone | 90% | 91% | 95% | 95% | 98% | 88% | 94% |
| resistance | | | | | | | |

As is understood from the results in Table 1, the ink-jet recording sheets of Examples including the gas-phase process silica in the invention had higher ink absorbing volume, ink absorptivity, black Dm and ozone resistance, and caused less beading and bronze glossiness than the sheet of Comparative Example 1 including the gas-phase process silica E having a silanol group density of 2.5 (SiOH groups/nm²). Moreover, the sheet of Comparative Example 2 including the gas-phase process silica F having a silanol group density of 0.7 (SiOH groups/nm²), had high ink absorbing volume, ink absorptivity and ozone resistance and had suppressed beading and bronze glossiness, but had remarkably decreased glossiness and black Dm.

1. An ink-jet recording medium comprising an ink-receiving layer comprising silica produced by a gas-phase process and a water-soluble resin on or over a support, wherein the density of silanol groups of the silica is from 1.0 to 2.3 SiOH groups/nm².

2. The ink-jet recording medium according to claim 1, wherein the silica is subjected to alkylsilane treatment.

3. The ink-jet recording medium according to claim 1, wherein the water-soluble resin is polyvinyl alcohol.

4. The ink-jet recording medium according to claim 2, wherein the water-soluble resin is polyvinyl alcohol.

5. The ink-jet recording medium according to claim 1, wherein the ink-receiving layer further comprises a hardener and a cationic resin.

6. The ink-jet recording medium according to claim 2, wherein the ink-receiving layer further comprises a hardener and a cationic resin.

7. The ink-jet recording medium according to claim 5, wherein the hardener is a boron compound.

8. The ink-jet recording medium according to claim 6, wherein the hardener is a boron compound.

9. The ink-jet recording medium according to claim 1, wherein the ink-receiving layer further comprises a water-soluble metal compound.

10. The ink-jet recording medium according to claim 2, wherein the ink-receiving layer further comprises a water-soluble metal compound.

11. The ink-jet recording medium according to claim 9, wherein the water-soluble metal compound is at least one compound selected from aluminum salts and zirconium salts.

12. The ink-jet recording medium according to claim 10, wherein the water-soluble metal compound is at least one compound selected from aluminum salts and zirconium salts.

13. The ink-jet recording medium according to claim 11, wherein one of the at least one compound selected from aluminum salts and zirconium salts is polyaluminum chloride.

14. The ink-jet recording medium according to claim 12, wherein one of the at least one compound selected from aluminum salts and zirconium salts is polyaluminum chloride.

15. The ink-jet recording medium according to claim 1, wherein the ink-receiving layer further comprises a water-soluble sulfur compound.

16. The ink-jet recording medium according to claim 2, wherein the ink-receiving layer further comprises a water-soluble sulfur compound.

17. The ink-jet recording medium according to claim 15, wherein the water-soluble sulfur compound is represented by at least one of the following formulae (1) and (2):
X—Y—S—CH₂—CH₂—S—Y—X Formula (1)
X—Y—S—S—Y—X Formula (2)
wherein Xs each independently represent a hydroxyl, carboxyl, carboxylic acid salt, acyl, amino, thiocarbamoyl, sulfamoyl or sulfoamino group, and Ys each independently represent an alkylene group which may have a substituent.

18. The ink-jet recording medium according to claim 16, wherein the water-soluble sulfur compound is represented by at least one of the following formulae (1) and (2):
X—Y—S—CH₂—CH₂—S—Y—X Formula (1)
X—Y—S—S—Y—X Formula (2)
wherein X's each independently represent a hydroxyl, carboxyl, carboxylic acid salt, acyl, amino, thiocarbamoyl, sulfamoyl or sulfoamino group, and Y's each independently represent an alkylene group which may have a substituent.

19. The ink-jet recording medium according to claim 1, wherein the BET specific surface area of the silica is 180 m²/g or more.

20. An inkjet recording medium comprising an ink-receiving layer comprising silica produced by a gas-phase process, a water-soluble resin and a water-soluble sulfur compound on or over a support, wherein the density of silanol groups of the silica is from 1.0 to 2.3 SiOH groups/nm², and the silica is subjected to alkylsilane treatment.
